(19) United States
(12) Patent Application Publication
(10) Pub. No.: US 2015/0237217 A1
(43) Pub. Date: Aug. 20, 2015

(54) PORTABLE WIRELESS COMMUNICATIONS SYSTEMS

(71) Applicant: Terra Ferma Inc., Monument, CO (US)

(72) Inventors: Dennis Leroy Roark, Monument, CO (US); Donald William Schmeyer, Colorado Springs, CO (US)

(21) Appl. No.: 14/380,025

(22) PCT Filed: Feb. 20, 2013
(86) PCT No.: PCT/US13/26955

§ 371 Date: Aug. 20, 2014

Related U.S. Application Data
(60) Provisional application No. 61/600,945, filed on Feb. 20, 2012.

(51) Int. Cl. H04M 19/00; H02J 7/00; F16L 3/223; F16L 3/04; F16L 3/06; H04M 1/725; H02J 7/35

(52) U.S. Cl. CPC H04M 19/001; H04M 1/725; H02J 7/0052; H02J 7/0042; H02J 7/35; F16L 3/04; F16L 3/06; F16L 3/2235

(57) ABSTRACT

A mobile wireless communications system includes a container having an interior compartment for holding one or more portable wireless communication components. The container can be adapted in various ways to facilitate use of the wireless communication components without having to unpack the components from the container. The system can include a shroud adapted to protect one or more electrical connections associated with wires connecting components inside the container to external electrical devices. The system can include a moveable support for holding one or more of the wireless communication components in the container and rotating the communication equipment to an orientation that provides better access without removing the components from the container. The system can also include features that help manage various wires that may be used to connect wireless communication components inside the container to other devices.

### FIELD OF INVENTION

The present invention relates generally to mobile wireless communication systems and more particularly to mobile wireless communication systems that can be operated for extended periods of time with minimal or no local access to electrical power or other support from public utilities.

### BACKGROUND

The widespread adoption of wireless communication devices such as cellular phones, smart phones, personal data devices, etc. has been accompanied by a substantial increase in the areas serviced by wireless communications infrastructure (e.g. cellular service providers, 3G networks, 4G networks, etc.) that relay communications from local wireless devices to and from their destinations. Yet there are still geographical areas in the United States and in other countries that lack infrastructure required to operate some or all wireless communications devices. Wireless communication from these so-called “off grid” areas may still be possible by using orbiting communication satellites. For example, portable communication equipment that can establish a link via satellite to communication infrastructure providing the desired wireless communication capability is commercially available. Similar communication equipment can sometimes be used to extend the range of local wireless devices to connect to a more remote communication infrastructure beyond the normal range of the devices without using a satellite.

Even if a particular area has some wireless communication infrastructure, the available infrastructure might not support all of the desired forms of communication. For example, the available wireless infrastructure in a particular area may support use of phones and other relatively lower-demand wireless communications but not support relatively higher-demand wireless communications such a video transmission. Portable communication equipment can be used in these instances to establish a link via satellite or other means to infrastructure capable of meeting the demands for the desired communication.

Moreover, sometimes areas that have well-developed wireless communication infrastructure can have some or all of the infrastructure disabled or destroyed by earthquakes, bad weather, and other natural disasters or similar events that can lead to disruptions of communication infrastructures. First responders in an area affected by a natural disaster or other event that can cause communication disruption need good communication capabilities to perform optimally. Portable communication equipment can also be used in these instances to establish a link to satellite or other communication infrastructure so teams of first responders can communicate with one another and with those outside the affected area notwithstanding the disablement or destruction of local communication infrastructure.

Even if existing communication infrastructure is sufficient to provide all desired communication capabilities, it is sometimes desirable to have capability to operate independently of the existing communication infrastructure. For example, in military applications it is desirable to not have to rely on local communications infrastructure which may be controlled and/or monitored by people who may be enemies, unfriendly, or unreliable in their support of the military objective. Law enforcement teams can have similar interests. Moreover, important commercial ventures may desire to have communication capabilities that are independent of or redundant with the existing infrastructure to ensure adequate communication capabilities notwithstanding any disruptions to existing communication infrastructure. For example, if a broadcaster is covering a commercially important sporting event or other event, the broadcaster may prefer to have independent communication capabilities (either as a backup or for use as the normal mode of communication) to ensure the ability to successfully meet business obligations by broadcasting the coverage of the event.

The present inventors have developed improvements in this field, which will be described in detail below.

### SUMMARY

One aspect of the invention is a mobile wireless communications system. The system includes a container having an interior compartment and an opening for accessing the interior compartment. A closure is moveable between a closed position in which the closure covers the opening and an open position in which the closure does not cover the opening. A wireless communication component is in the interior compartment. The wireless communication component is adapted to receive and/or broadcast wireless communication signals. The system includes a panel having an interior side accessible from the interior compartment and an exterior side accessible from outside the interior compartment. The interior side of the panel is adapted for connection to the wireless communication component. The exterior side is adapted for connecting an electrical wire to the exterior side of the panel to electrically connect a device outside the interior compartment to the wireless communication component in the interior compartment. A shroud is secured to the container and surrounds a perimeter of the panel and partially encloses the exterior side of the panel. The shroud has an opening at its distal end for entry of said electrical wire into the shroud for making an electrical connection to the exterior side of the panel. There is a closure at the distal end of the shroud adapted to selectively widen and constrict the opening into the shroud.

Another aspect of the invention is a portable off-grid wireless communication system for satellite-based communications of the type wherein the communication system can operate for an extended period of time without receiving any electrical power from a public utility company. The system includes wireless communication equipment and a battery for powering the wireless communication equipment. The system has a wind turbine for recharging the battery and/or powering the wireless communication equipment and a portable mast for supporting the wind turbine above the ground. An electrical line connects the wind turbine to at least one of the battery and the wireless communication equipment. The electrical line extends through a hollow center of the mast so the mast surrounds at least the end of the electrical line connected to the wind turbine.

Yet another aspect of the invention is a mobile wireless communications system. The system includes a container having a compartment and an opening for accessing the compartment. A closure is moveable between a closed position in which the closure covers the opening and an open position in which the closure does not cover the opening. The system has a support adapted to hold a wireless communication component in the compartment. The support is secured to the container and moveable relative to the container between a first position in which the support is positioned to hold the wireless communication component in the compartment while the closure is in its closed position and a second position in which the support is positioned to hold the wireless communication component so at least a portion of the wireless communication component extends through the opening for facilitating access to the wireless communication component when the closure is in the open position.

Another aspect of the invention is a cable clip for securing one or more relatively small diameter cables to a larger diameter tubular support. The clip has a body made of a resilient material and extending partially around a central space having a generally circular cross section. The body is configured so there is an opening for relative movement of the tubular support and body to snap the tubular support into the central space through the opening so the tubular support extends axially through the central opening and segments of the body are positioned to adjoin the tubular support. The body has a plurality of lobes extending radially outward from the central space between said segments thereof to define cable-receiving spaces. The cable-receiving spaces defined by the lobes are generally circular extensions of the central opening for holding one of the relatively smaller diameter cables adjacent the relatively larger diameter tubular support.

Other objects and features of the invention will in part be apparent and in part pointed out hereinafter.

### BRIEF DESCRIPTION OF THE DRAWINGS

FIG. 1 is a perspective of one embodiment of a mobile communication backpack of the present invention, showing one side of the backpack;

FIG. 2 is a perspective of the backpack similar to FIG. 1 showing a closure of the backpack in an open position and showing wireless communication components inside the backpack;

FIG. 3 is another perspective of the backpack of FIG. 1 showing the opposite side of the backpack;

FIG. 4 is a schematic top view of the backpack in a configuration in which a closeable opening at the top of the backpack is open to show a plurality of dividers inside the backpack;

FIG. 5 is a schematic illustration of one embodiment of a shroud that facilitates connection of wireless components inside the backpack to equipment outside the backpack, the shroud being illustrated in a configuration for accessing electrical connectors integrated with the backpack;

FIG. 6 is another schematic illustration of the shroud in a configuration for protecting electrical connections inside the shroud from the elements and providing strain relief to wires connected to the connectors in the shroud;

FIG. 7 is a schematic illustration of the backpack showing various electronic equipment outside the back pack, including a pair of solar panels, connected to wireless communications in the backpack;

FIG. 8 is a schematic illustration of another embodiment of a mobile communication system of the present invention showing various electronic communication equipment, including solar panels, a satellite dish, and a wind turbine, connected thereto;

FIG. 9 is a schematic rear elevation of the mobile communication system illustrated in FIG. 8;

FIG. 10 is a schematic top plan of the mobile communication system of FIGS. 8 an 9 showing a lid of the container in the open position;

FIG. 11 is a side schematic elevation of the system of FIGS. 8-10 with the lid removed and the container in cross section to reveal internal features thereof;

FIG. 12 is a side schematic elevation similar to FIG. 11, but showing a support for wireless communication equipment rotated to allow better access to the equipment;

FIG. 13 is a front schematic elevation of the system in the configuration illustrated in FIG. 12;

FIG. 14 is an exploded schematic illustration of one embodiment of an internal electrical connection to a wind turbine of the present invention, showing the parts thereof in a disconnected configuration;

FIG. 15 is a schematic illustration of the electrical connection in FIG. 14 in a connected configuration;

FIG. 16 is a schematic top plan view of one embodiment of a cable clip of the present invention; and

FIG. 17 is a schematic side elevation of the cable clip.

Corresponding reference characters indicate corresponding parts throughout the drawings.

### DETAILED DESCRIPTION

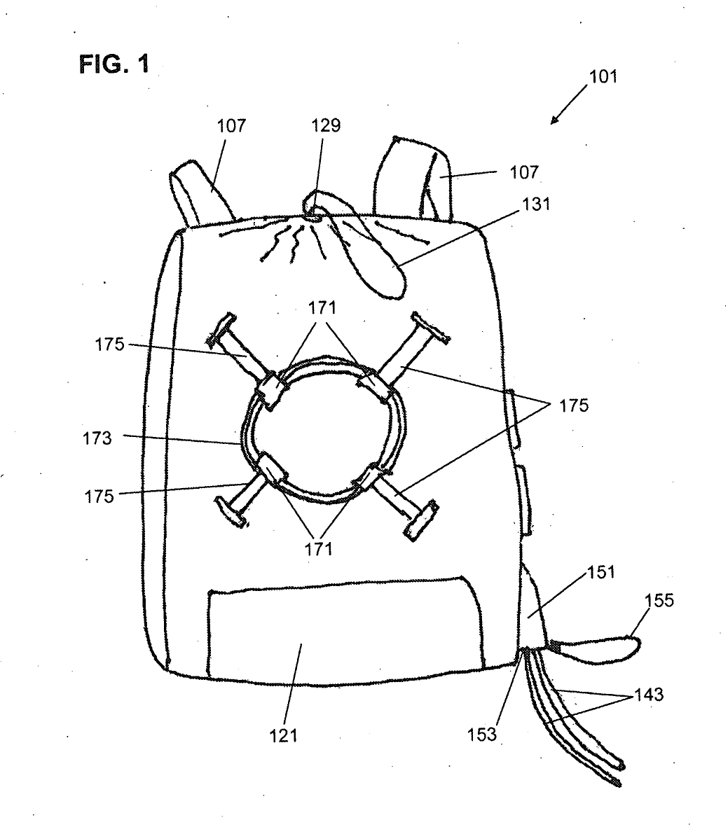

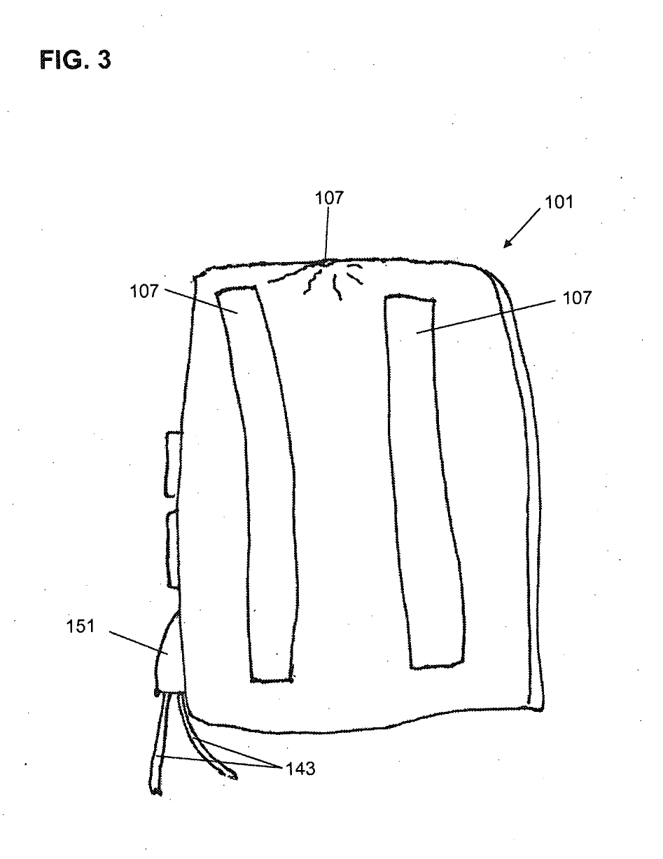

Referring to the drawings, first to FIGS. 1-6, one embodiment of a mobile wireless communications system is illustrated as a backpack 101. As illustrated in FIG. 3, the backpack-includes a pair of shoulder straps 107 that form loops. The straps 107 can be positioned so a person can insert his or her arms through the loops to secure the backpack 101 to his or her back in substantially the same way as a conventional backpack. Although the embodiment illustrated is a backpack, it could instead be a “manpack” (i.e., so part of it is mounted on the front of a person), suitcase, or other type of portable container for holding wireless communication components within the scope of the invention.

As will be better understood in view of the description that follows, the system 101 is adapted to allow a person to carry wireless communication equipment 115 through rugged unsettled terrain (such as mountains, deserts, forests, etc.) while minimizing the amount of wireless communication components that need to be unpacked to use the mobile communication system. This makes it easy to set the mobile wireless communication system 101 up for use and/or repack it quickly. Any wireless communication components 115 that do not need to be unpacked to use the system 101 are also better protected from the weather. Those skilled in the art will appreciate these features can make the system attractive for a wide range of diverse applications, including military, first responders to a natural disaster or other event that may be associated with a disruption of normal communication, media coverage (e.g., of sporting events, news stories, or other events that take place outdoors or in remote locations), camping, outdoor adventuring, etc., and the invention is not limited to any particular communication application.

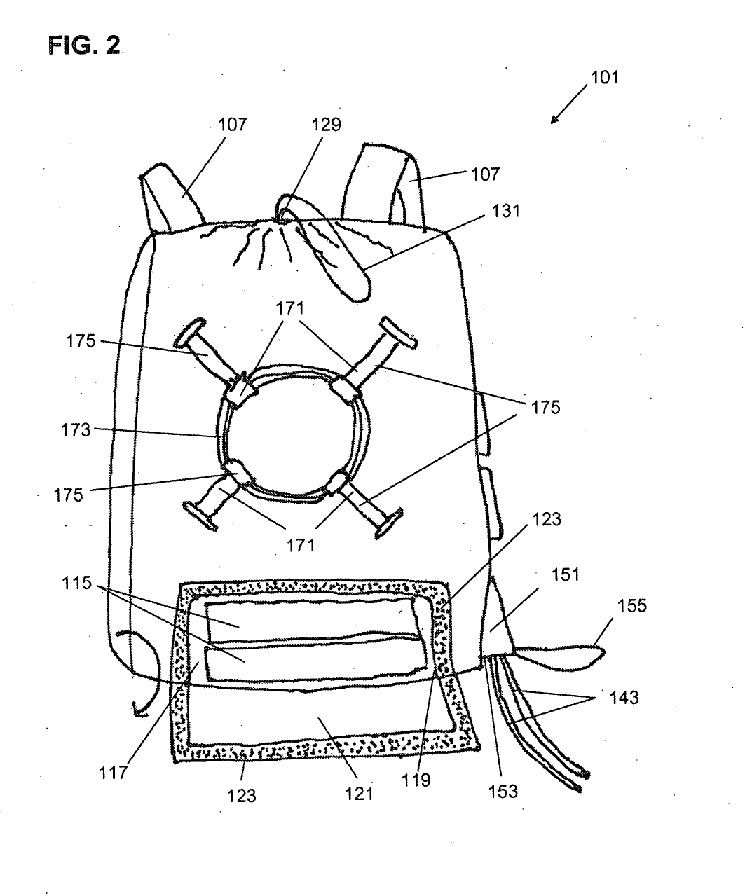

Referring to FIG. 2, the backpack 101 (broadly, a container) has an interior compartment 117. The container has an opening 119 for accessing the interior compartment 117 and a closure 121 moveable between a closed position in which the closure covers the opening and an open position in which the closure does not cover the opening. There can be any number of compartments inside the backpack within the scope of the invention. Likewise, compartments can be partially or completely subdivided in any manner desired to provide a convenient number of compartments and/or sub-compartments having the desired shapes and sizes. Some of the compartments are suitably small pockets on the outside of the backpack 101 for holding one or more smart phones or other personal electronic devices so they can be readily accessed without opening other compartments.

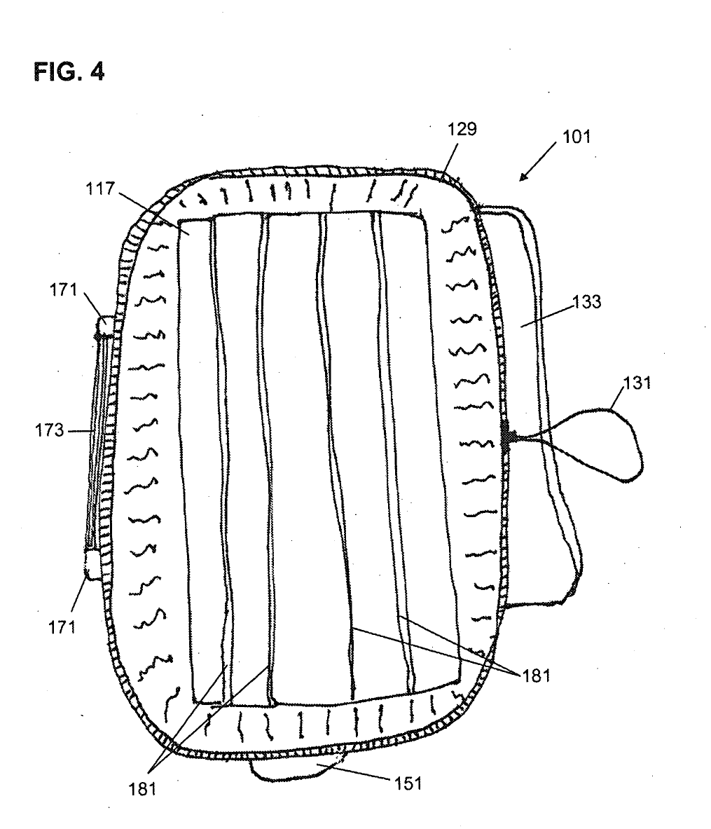

The number of openings and closures for each compartment can vary within the scope of the invention. In the illustrated embodiment, for example, there is one opening 119 (FIGS. 1 and 2) positioned in the rear of the backpack 101 at its bottom/lower end. The closure 121 for this opening 119 is a flexible flap (e.g., of fabric or other material) that can be rotated in the direction indicated by the arrow in FIG. 2 to move the flap from the closed position to the open position. Velcro 123 or other suitable releasable fasteners (e.g., a zipper, snaps, or the like) allow the closure 121 to be selectively moved between the open position (FIG. 2) and closed position (not shown) while releasably retaining the closure in the closed position. The backpack 101 has another opening 129 at its top (FIGS. 1, 2, and 4) and a drawstring 131 that is moveable to open or close the opening. If desired, another closure such as a flap 133 (FIG. 4) of material can be provided that can be pulled over, and thereby cover, the closed opening 129 after the drawstring 131 has been pulled tight for additional protection.

The interior compartment 117 is sized and shaped to receive one or more wireless communication components 115. FIG. 2 shows a pair of wireless communication components 115 in the interior compartment 117. The system 101 is a modular system and can be adapted to support a wide variety of different wireless communication components 115 in the interior compartment 117. Some non-limiting examples of suitable wireless communication components 115 that can be received in the interior compartment 117 include: components for two-tiered Wide Area Network (WAN) bandwidth (256 kbps and 512 kbps); IP network acceleration; low bandwidth video teleconferencing, wireless routers (e.g., Ethernet routers), WiFi components (e.g., WiFi access and/or backhaul or portable MESH network coverage extenders), portable radio equipments (e.g., P25 or Analog Trunk radio components), satellite telephone components, cellular hotspot components, voice over internet components, radio over internet components, security system integration components, SCADA Network integration components, and many others. The wireless communication component(s) 115 in the interior compartment 117 can suitably receive and/or broadcast signals without being removed from the backpack 101 and without being removed from the interior compartment.

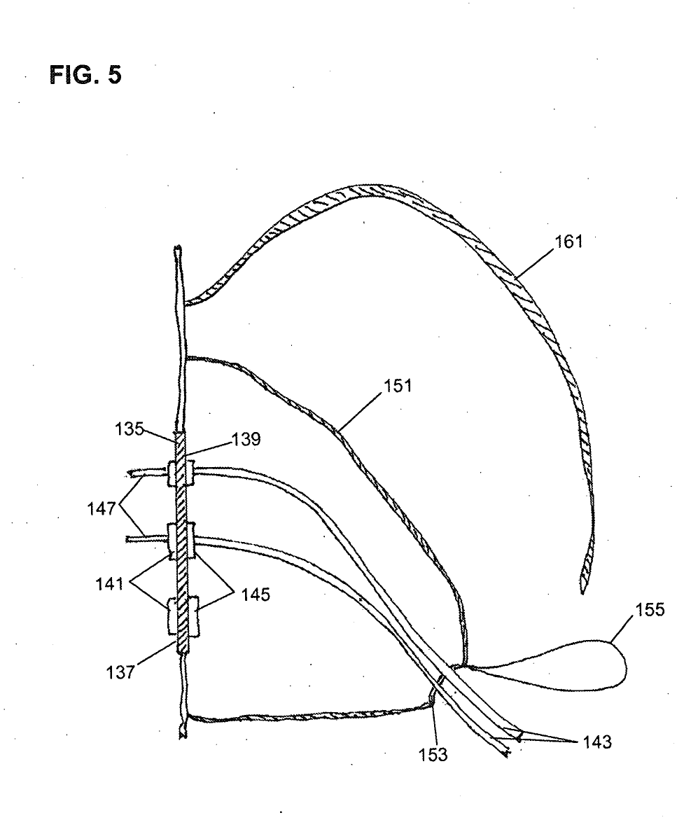

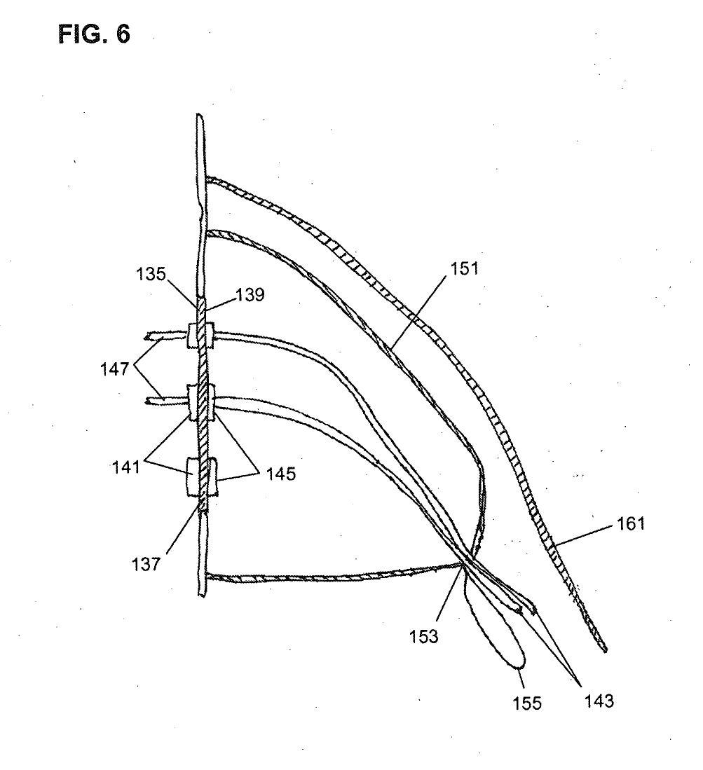

As illustrated in FIGS. 5 and 6, the backpack 101 or other container suitably includes a panel 135 having an interior side 137 accessible from the interior compartment 117 and an exterior side 139 accessible from outside the interior compartment. For example, the panel 135 can be made from a sheet of durable plastic or other material and can be sewn or otherwise integrated into and secured to the side of the backpack 101 so one side 139 of the panel is on the outside of the interior compartment 117 and the opposite side 137 is inside the interior compartment. The interior side 137 of the panel 135 is adapted for connection to one or more wireless communication components 115 in the interior compartment 117. For example, various sockets, plugs, and/or other suitable electrical connectors 141 can be provided on the panel 135 for connecting the interior side 137 of the panel to the wireless communication component(s) 115 in the interior compartment 117 using one or more wires 147. The exterior side 139 of the panel 135 is adapted for connecting one or more electrical wires 143 to the exterior side 139 of the panel to electrically connect one or more devices 115′ (e.g., solar panels, satellite dish, fuel cell, battery, vehicular power outlet, etc.) outside the interior compartment 117 to the wireless communication component(s) 115 in the interior compartment. For example, sockets, plugs, and/or other suitable electrical connectors 145 can be provided on the exterior side 139 of the panel 135. The connectors 141 on the interior side 137 of the panel 135 are in electrical connection with corresponding connectors 145 on the exterior side 139 of the panel 135 so electrical transmissions can be fed through the panel between the corresponding connectors.

A shroud 151 is secured to the backpack 101 or other container so it surrounds a perimeter of the panel 135 and partially encloses the exterior side 139 of the panel. The shroud 151 is suitably made of a flexible material, such as leather or fabric. The shroud 151 is also suitably made of a weather resistant material that repels or is impermeable to water. The shroud 151 has an opening 153 at its distal end. Any electrical wires 143 connected to the exterior side 139 of the panel 135 suitably extend into the shroud 151 through this opening 153. A drawstring 155 or other suitable closure adapted to selectively widen and constrict the distal opening 153 into the shroud 151 is positioned at the opening.

To connect the wireless communication component(s) 115 in the interior compartment 117 to external devices 115′, a wire 143 from the external device is extended into the shroud 151 through the opening 153 at its distal end while the opening is relatively widely open (FIG. 5) and connected to the exterior side 139 of the panel 135 using a connector 145 that is connected to the desired internal wireless communication components. Then, the opening 153 at the distal end of the shroud 151 is cinched up (e.g., using the drawstring 155 as illustrated in FIG. 6) so the connection between the external wire 143 and the exterior side 139 of the panel 135 is substantially enclosed within the shroud 151. This helps protect the connection between the external wire 143 and the exterior side 139 of the panel 135 from water and debris. It also helps provide strain relief so if there is any tension in the external wire 143 (e.g., weight of the wire), the shroud 151 bears at least some of the tension. This helps the wire 143 remain securely connected to exterior side 139 of the panel 135.

If desired, the backpack 101 or other container may include another protective flap 161 moveable from a first position in which the shroud 151 is uncovered and a second position in which the shroud is at least partially covered by the flap. The flap 161 can be secured to the backpack 101 above the shroud 151 and extend down below the shroud in the position in which it covers the shroud to help keep water out of the shroud.

Referring to FIGS. 1 and 2, the backpack includes a plurality of clips 171 (e.g., four clips as illustrated) for retaining a coil of wire 173. The clips 171 are suitably positioned on the rear of the backpack 101 so the coiled wire 173 is held on the side of the backpack that is normally not adjacent the back of a person wearing the backpack. Various types of clips can be used within the scope of the invention. In the illustrated embodiment, the clips 171 are hooks at the ends of adjustable straps 175. Each strap 175 is secured to the backpack 101 at a different position spaced circumferentially around a position where the coiled wire is to be received and retained. Each strap 175 is extendable radially inward. To retain a coiled wire 173 on the backpack 101 using the clips 171, a coiled wire is placed centrally between the extended straps 175. Then the clips 171 are secured to the bundle of coiled wire 173 and the straps are pulled tight to hold the coil.

As illustrated in FIG. 4, the interior compartment 117 is divided into sub-compartments to help organize various items that may be housed in the compartment. In FIG. 4, the upper portion of the interior compartment 117 is separated into sub-compartments by four vertical dividers 181. The upper portion of the interior compartment 117 (FIG. 4) can suitably be divided from a bottom portion of the interior compartment (FIG. 2) by a horizontal divider (not shown). Alternatively, there may be no divider separating the communication equipment 115 from the upper portion of the interior compartment 117. For example, any items placed in the backpack 101 or other container between the dividers 181 may be supported by the upper surface(s) of the communication equipment 115 within the scope of the invention.

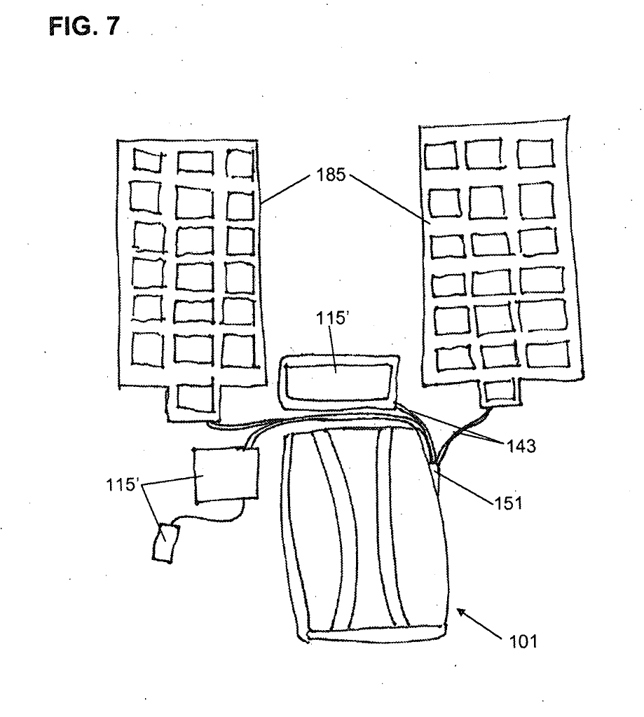

One of the items that may be stored in the upper portion of the interior compartment 117 is a solar panel 185 (FIG. 7) for generating energy for powering the communication equipment 115 and other components of the communication system 101. The solar panel 185 is suitably adapted so it has a folded configuration (not shown) in which the solar panel can fit within the interior compartment 117 and an unfolded configuration for generating energy while the solar panel is outside the interior compartment, as illustrated in FIG. 7. When the solar panel 185 is unfolded to generate energy, it can be connected to the wireless communication component(s) 115 inside the compartment 117 by one or more electrical wires 143 extending into the shroud 151 and connecting to the internal components through the panel 135 enclosed by the shroud. Suitable solar panels that can be folded to fit inside the backpack 101 are commercially available from various vendors.

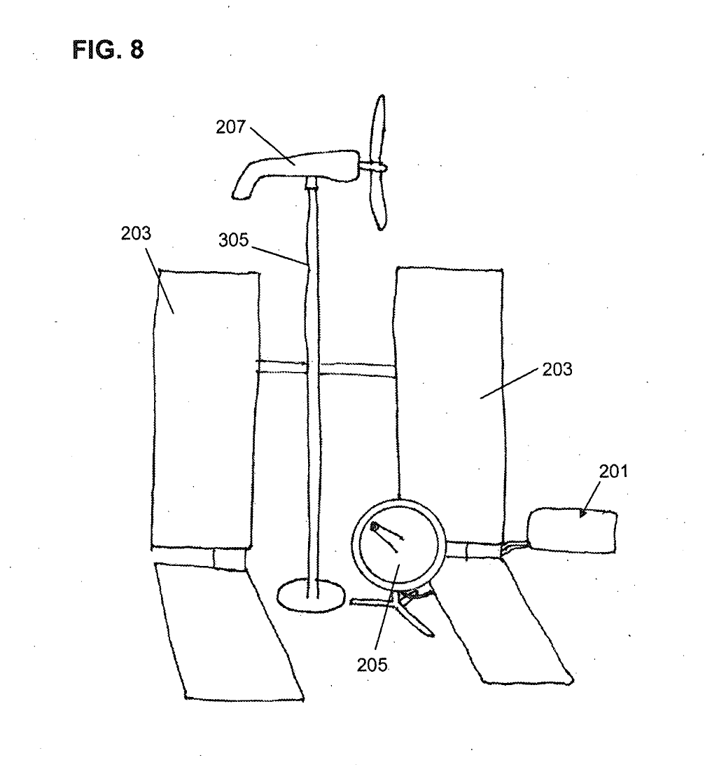

Referring now to FIG. 8, another embodiment of a mobile communication system 201 of the present invention includes a pair of portable foldable solar panels 203, a portable satellite dish 205, and a wind turbine 207. Except as noted, the solar panels 203, satellite dish 205, and wind turbine 207 are suitably conventional devices. Various commercial vendors supply these devices. The system also includes a container 211, for containing one or more wireless communication components 115 of the system. The container 211 is suitably a hard shell suitcase, as illustrated. It is contemplated the container 211 can be sized and shaped so it can fit within the space allotted for carryon luggage by commercial airlines. It is understood the container does not necessarily need to include a hard outer shell and can have sizes, shapes, and configurations different from what is shown in the drawings within the broad scope of the invention.

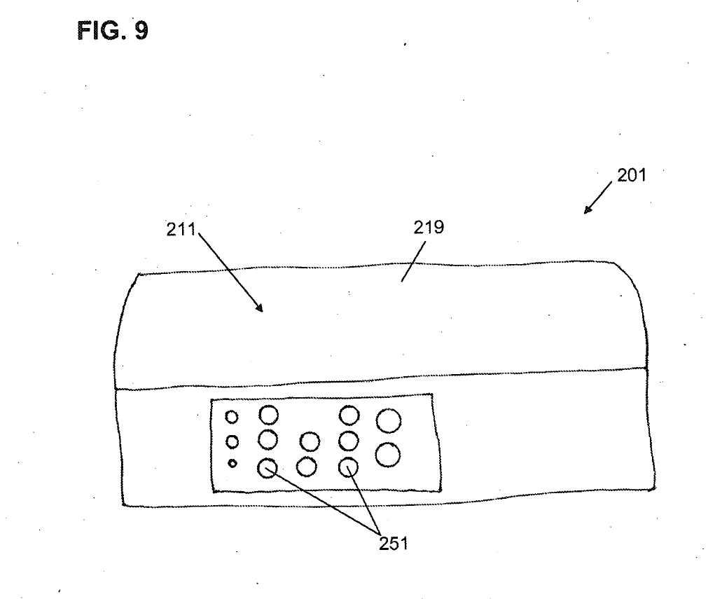

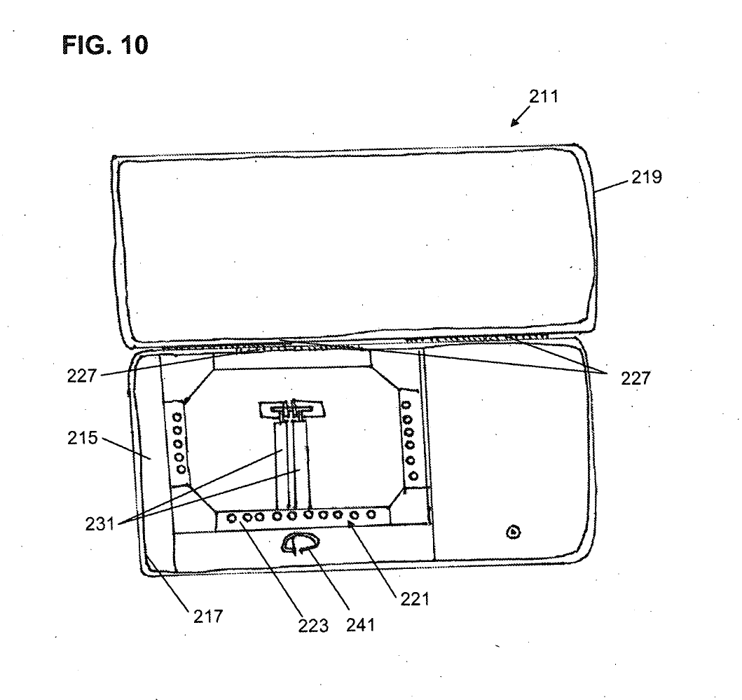

As illustrated in FIGS. 9-13, the container 211 has a compartment 215 for holding one or more wireless communication components 115 and an opening 217 for accessing the compartment. The container 211 also has a closure 219 (e.g., lid) moveable between a closed position (FIG. 9) in which the closure covers the opening and an open position (FIG. 10) in which the closure does not cover the opening.

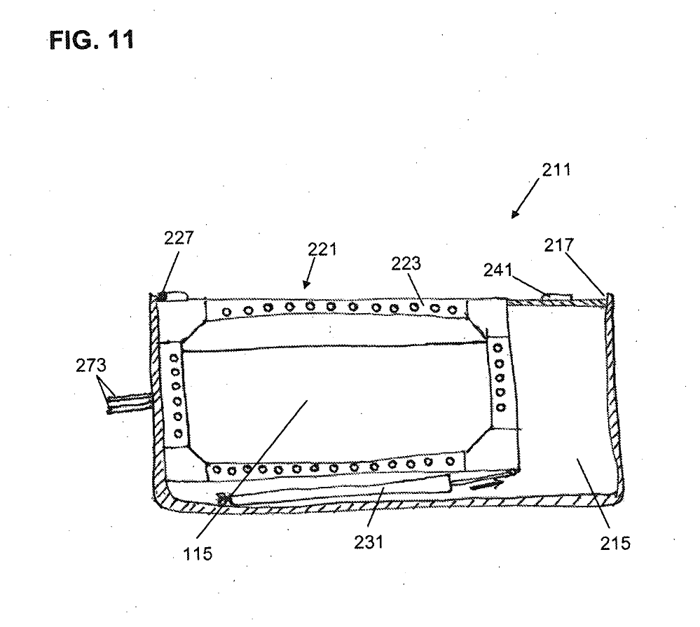

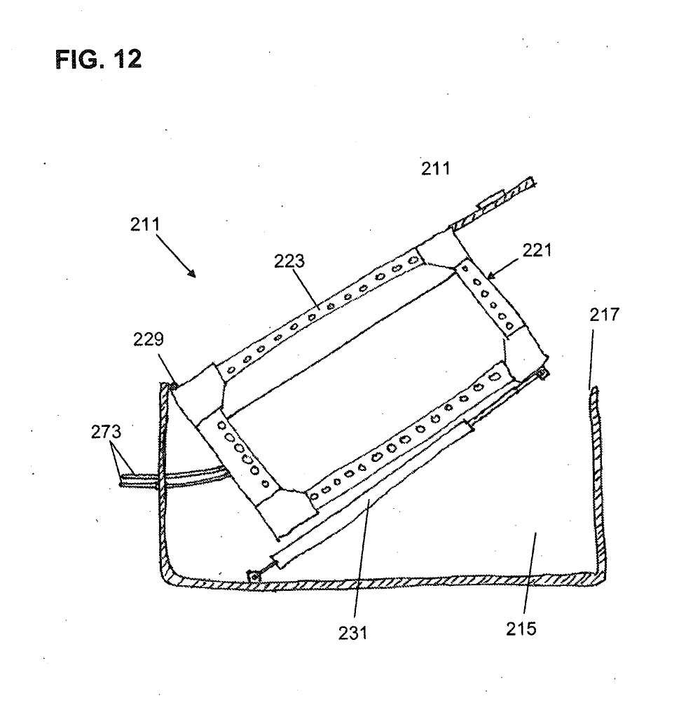

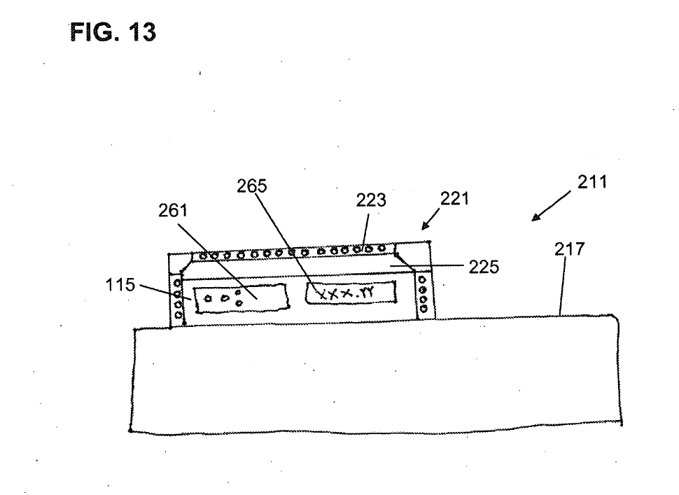

The container 211 has a support 221 adapted to hold one or more wireless communication components 115 in the compartment. The wireless communication component 115 can suitably include any of the components listed above in connection with the backpack 101. The support 221 is secured to the container 211 and moveable relative to the container between a first position (FIGS. 10 and 11) in which the support is positioned to hold the wireless communication component fully within the compartment 215, e.g., while the closure 219 is in its closed position and a second position (FIGS. 12 and 13) in which the support is positioned to hold the wireless communication component so at least a portion of the wireless communication component extends through the opening for facilitating access to the wireless communication component when the closure is in the open position.

One or more pneumatic actuators 231 (e.g., two in the illustrated embodiment) are adapted to move the support 221 between the first and second positions. As illustrated in FIGS. 10-13, the pneumatic actuators 231 are suitably connected to the support 221 and to a bottom of the container 211 so each of the pneumatic actuators extends generally along the bottom of the container and is in a retracted configuration when the support is in the first position.

For example, the support 221 suitably comprises a frame 223 having an opening 225 (FIG. 13) configured to allow the wireless communication component(s) 115 to slide into the frame so the frame extends around the top, bottom, and all sides of the component. Suitable frames or materials for constructing suitable frames can be obtained from Star Case Manufacturing Co. Inc. and other commercial vendors. As illustrated in FIGS. 10-12, the support 221 is secured to the container 211 (e.g., by a hinge 227 or other suitable connector at the top of the frame) for pivoting movement of the support relative to the container. As illustrated, the hinge 227 connecting the support 221 to the container 211 is suitably adjacent a hinge 229 connecting the closure 219 (e.g., lid) to the container. The pneumatic actuators 231 are suitably connected to the support frame 223 at a position below the top of the frame (e.g., at a bottom corner of the frame opposite the hinge 227) so extension of the pneumatic actuator(s) 131 requires pivoting movement of the support 221 relative to the container.

Various types of pneumatic actuators can be used within the scope of the invention. For example, each of the pair of pneumatic actuators 231 in the illustrated embodiment is suitably a gas spring biased toward the extended configuration as indicated by the arrow in FIG. 11 (e.g., with a force of about 100 N). Suitable gas springs can be obtained commercially from Stabilus GmbH (e.g., Part number 280523.0100N) and other vendors. A latch 241 (FIG. 11) on the support 221 can be used to hold the support in the first position against the bias of the pneumatic actuator(s) 231. Whether or not a latch is used, the pneumatic actuator(s) 231 can be adapted so user can activate the actuator(s) and cause extension thereof by pushing against the support 221 to move the actuator(s) to a more contracted position to release the actuators from a locked configuration. Although there are two actuators 231 in the illustrated embodiment, it is understood that the number of actuators can vary and that a single actuator or more than two actuators can be used within the scope of the invention.

The support 221 has an opening 225 (FIG. 13) configured to allow the wireless communication component(s) 115 to slide into the support 221. This opening 225 is positioned to face a side of the container 211 when the support is in the first position (see FIG. 11). When the support 221 is in the second position (e.g., as in FIGS. 12 and 13) this opening 225 extends above the opening 217 of the container 211 to facilitate insertion and/or removal of the wireless communication component(s) 115 from the support 221 through the opening 225. Further, as illustrated in FIG. 13, the wireless communication component(s) 115 may include one or more panels including at least one of a control panel 261 and a display panel 265. The wireless communication component 115 can be positioned in the support 221 so any such panels face the same side of the container 221 as the opening 225 does when the support is in the first position. This way the panel is easily visible and/or accessible (e.g., through the opening 225 in the support 221) when the support is in the second position.

As illustrated in FIG. 9, the back of the container 211 suitably has a plurality of openings 251. The openings 251 can be used to connect the wireless communication component 115 in the support 221 to external devices 115′ (e.g., solar panels 203, satellite dish 205, wind turbine 207, batteries, vehicles, or other devices) using electrical wires (not shown) extending through the openings. The openings 251 can also provide cooling for the wireless communication component 115 when the container 211 is closed. The openings 251 are suitably configured so wires 273 extending through the openings can slide through the openings farther into or out of the container. For example, at least some of the openings 251 are suitably wider than the wires 273 that are typically used with the communication component(s) 115 so the openings do not constrain movement of the wires relative to the openings. This helps the wires 273 remain connected to wireless communication component(s) 115 as the components are pivoted relative to the openings by movement of the support 221.

Depending on the various external equipment 115′ that may be used in the communication systems 101, 201 it is possible that there may be several wires/cables that need to be managed. It is desirable to have improved ways to manage these various wires so they are less likely to interfere with people and operations being conducted in the vicinity of the system 201 as well as to facilitate reliable quick set up and take down of the system.

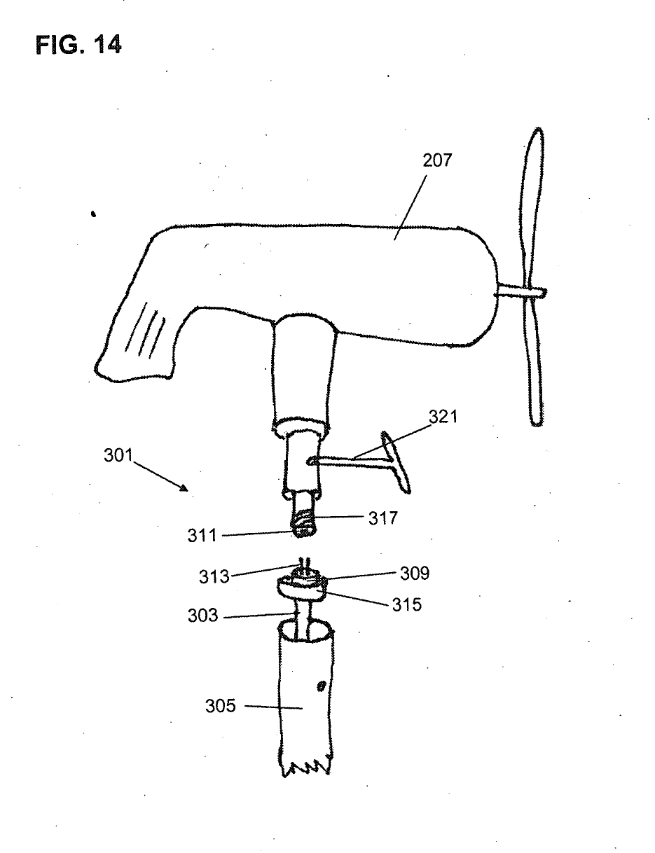

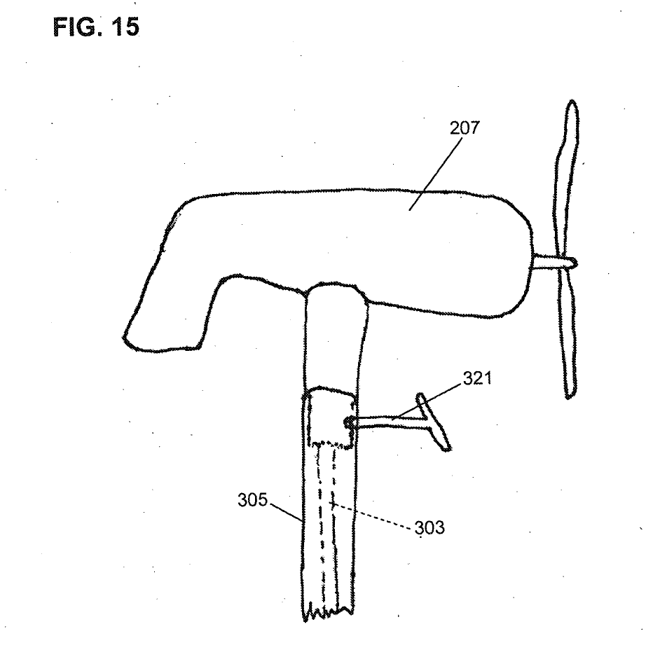

FIGS. 14 and 15 illustrate one embodiment of an electrical connection 301 suitable for connecting an electrical wire 303 to a wind turbine 207 of a portable off-grid wireless communication system (such as either of the systems 101, 102 described above) to provide power to the system and/or to recharge a battery of the system. The electrical connection 301 is made generally at the physical connection between the wind turbine 207 and a portable mast 305 for supporting the wind turbine above the ground. The electrical line 303 extends through a hollow center of the mast 305 so the mast surrounds at least the end 309 of the electrical line 303 connected to the wind turbine 207. The wind turbine 207 includes a socket, plug or other suitable electrical connector 311 and the end 309 of the wire 303 includes a suitable mating electrical connector 313 so the wire can be electrically connected to the wind turbine by joining the electrical connectors. As illustrated in FIG. 14, the wire 303 suitably has a threaded collar 315 on its end 309 that can be screwed onto corresponding threads 317 on the end of the wind turbine 207 after the connectors 311, 313 are joined to physically retain the wire in electrical connection with the wind turbine. A quick release mechanism 321 suitably mechanically couples the end of the mast 305 to the wind turbine 207, as illustrated in FIGS. 14 and 15. As illustrated in FIG. 15, when the electrical line 303 is plugged into the wind turbine 207 and the mast 305 is physically connected to the wind turbine (e.g., by the quick release mechanism 321), the electrical connection between the wire and the wind turbine is shielded from the elements and securely held together by the physical connection between the mast and wind turbine as well as the internal threaded connection between the collar 315 on the electrical line 303 and the threads 317 on the wind turbine.

Another advantage of the internal electrical connection 301 between the electrical wire 303 and the wind turbine 207 is that the exterior of the mast 305, which is used to support an externally positioned wire to the wind turbine in prior art systems, is less cluttered and has the capacity to support additional wires connecting to other components of the wireless communication system.

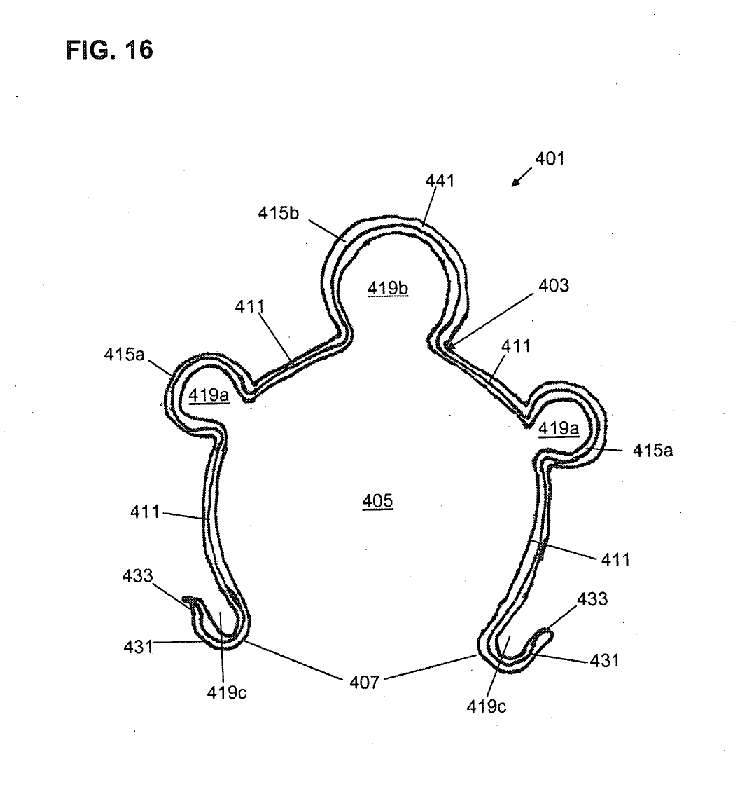

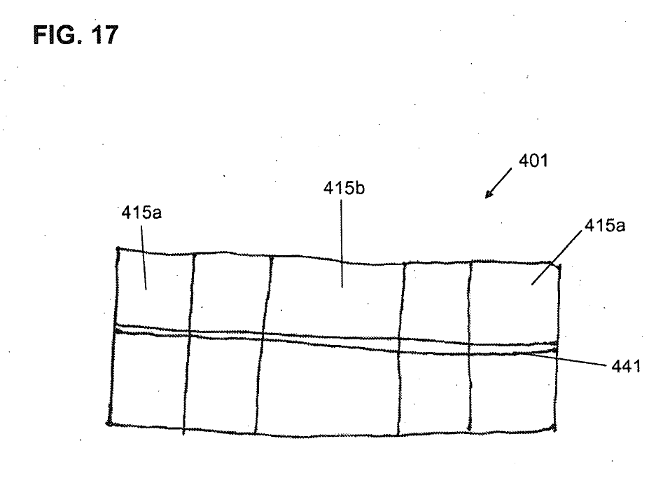

FIGS. 16 and 17 show one embodiment of a cable clip 401 that can be used to secure one or more relatively small diameter cables (such as the various wires used in the communication system) to a larger diameter tubular support, such as the mast 305 for the wind turbine 207. The clip 401 includes a body 403 made of a resilient material and extending partially around a central space 405 having a generally circular cross section. The body 403 is configured so there is an opening 407 for relative movement of the tubular support (e.g., mast 305) and body to snap the tubular support into the central space 415 through the opening. When the clip 401 is snapped onto the mast 305 or other support in this manner, the support extends axially through the central opening 405 and segments 411 of the body are positioned to adjoin the tubular support. The body 403 has a plurality of lobes 415a, 415b (e.g., three lobes) extending radially outward from the central space 405.

The lobes 415a, 415b define cable-receiving spaces 419a, 419b that are positioned between the segments 411 of the body adjacent the mast 305 or other support. The cable-receiving spaces 419a, 419b are suitably generally circular extensions of the central opening 407, as illustrated. The lobes 415a, 415b are C-shaped segments of the body 403 configured so the relatively smaller diameter cables can be snapped into the cable-receiving spaces 419a, 419b before the relatively larger mast 305 or other support is snapped into the central space 405. Each of the cable-receiving spaces 419a, 419b formed by the lobes 415a, 415b can be used to hold a wire or cable adjacent the mast 305 or other tubular support.

The lobes 415a, 415b can have different sizes from one another to facilitate use of the clip 401 to secure wires/cables having various different diameters to the mast/support. For example, the cable-receiving spaced 419a defined by one of the lobes 415a suitably has a first diameter while the cable-receiving space 419b defined by one or more other lobes 415b has a second diameter different from the first diameter. In the illustrated embodiment, the largest diameter lobe 415b is positioned generally opposite the opening 407 for snapping the clip 401 onto the mast 305 or other support. A smaller diameter lobe 415a is positioned on either side of the largest diameter lobe 415b between the largest diameter lobe and the opening 407 for snapping the clip 401 onto the mast 305 or other support. As illustrated, the two smaller diameter lobes 415a have diameters that are about equal, but the diameters of these lobes can be different if desired.

The body 403 has a pair of ends 431 on opposite sides of the opening 407 for snapping the clip 401 onto the mast 305 or other support. The ends 431 are suitably doubled back on themselves to form hooks 433 so each of the hooks defines an additional cable-receiving space 419c at the ends of the body 403. Wires or cables can be snapped into the cable-receiving spaces 419c formed by the hooks 433 after the clip 401 has already been snapped onto the mast 315 or other support. The hooks 433 can be configured for holding cables that are about equal in diameter, as illustrated, or one of the hooks can be larger in diameter than the other. In the illustrated embodiment, the hooks 433 are configured so the cable-receiving spaces 419c formed by the hooks are smaller than any of the cable-receiving spaces 419a, 419b formed by the lobes 415a, 415b, although this is not required within the broad scope of the invention.

The body 403 includes a rib 441 extending radially outwardly from the lobes 415a, 415b and the segments 411 of the body between the lobes. The rib 441 adds stiffness and structural integrity to the clip 401. The clip 401 is suitably molded as one piece from a resilient moldable polymeric material.

When introducing elements of the present invention or the preferred embodiments thereof, the articles “a”, “an”, “the”, and “said” are intended to mean that there are one or more of the elements. The terms “comprising”, “including”, and “having” are intended to be inclusive and mean that there may be additional elements other than the listed elements.

As various changes could be made in the above compositions, products, and methods without departing from the scope of the invention, it is intended that all matter contained in the above description and shown in the accompanying drawings shall be interpreted as illustrative and not in a limiting sense.

What is claimed is:

1. A mobile wireless communications system comprising:
a container having an interior compartment, the container having an opening for accessing the interior compartment and a closure moveable between a closed position in which the closure covers the opening and an open position in which the closure does not cover the opening;
a wireless communication component in the interior compartment, the wireless communication component being adapted to receive and/or broadcast wireless communication signals;
a panel having an interior side accessible from the interior compartment and an exterior side accessible from outside the interior compartment, the interior side of the panel being adapted for connection to the wireless communication component, the exterior side being adapted for connecting an electrical wire to the exterior side of the panel to electrically connect a device outside the interior compartment to the wireless communication component in the interior compartment;
a shroud secured to the container and surrounding a perimeter of the panel and partially enclosing the exterior side of the panel, the shroud having an opening at its distal end for entry of said electrical wire into the shroud for making an electrical connection to the exterior side of the panel; and
a closure at the distal end of the shroud, the closure being adapted to selectively widen and constrict the opening into the shroud.

2. A mobile wireless communication system as set forth in claim 1 wherein the closure at the distal end of the shroud comprises a drawstring.

3. A mobile wireless communications system as set forth in claim 1 wherein the container comprises a backpack.

4. A mobile wireless communications system as set forth in claim 3 wherein the backpack comprises a pair of shoulder straps, the shoulder straps forming a pair of loops that are positionable so a person can insert his or her arms through the loops to secure the backpack to his or her back.

5. A mobile wireless communications system as set forth in claim 1 further comprising a solar panel for generating energy for powering the wireless communication system, the solar panel being adapted so it has a folded configuration in which the solar panel can fit within the container and an unfolded configuration for generating energy while the solar panel is outside the container.

6. A mobile wireless communication system as set forth in claim 5 wherein the solar panel is outside the container and connected by said wire to the exterior side of said panel to connect the solar, panel to the wireless communication component in the interior compartment.

7. A portable wireless communication system for satellite-based communications of the type wherein the communication system can operate for an extended period of time without receiving any electrical power from a public utility company, the system comprising:
wireless communication equipment;
a battery for powering the wireless communication equipment;
a wind turbine for recharging the battery and/or powering the wireless communication equipment;
a portable mast for supporting the wind turbine above the ground; and
an electrical line connecting the wind turbine to at least one of the battery and the wireless communication equipment, the electrical line extending through a hollow center of the mast so the mast surrounds at least the end of the electrical line connected to the wind turbine.

8. A portable wireless communication system as set forth in claim 7 further comprising a quick release coupling mechanically coupling the end of the mast to the wind turbine.

9. A portable wireless communication system as set forth in claim 7 further comprising a cable clip for securing one or more relatively small diameter cables to the mast.

10. A portable wireless communication system as set forth in claim 9 wherein:
the clip comprises a body made of a resilient material and extending partially around a central space having a generally circular cross section,
the body is configured so there is an opening for relative movement of the mast and body to snap the tubular support into the central space through the opening so the mast extends axially through the central opening and segments of the body are positioned to adjoin the mast,
the body has a plurality of lobes extending radially outward from the central space between said segments thereof to define cable-receiving spaces, and
the cable-receiving spaces defined by the lobes are generally circular extensions of the central opening for holding one of the relatively smaller diameter cables adjacent the relatively larger diameter tubular support.

11. A mobile wireless communications system comprising:
a container having a compartment, the container having an opening for accessing the compartment and a closure moveable between a closed position in which the closure covers the opening and an open position in which the closure does not cover the opening;
a support adapted to hold a wireless communication component in the compartment, the support being secured to the container and moveable relative to the container between a first position in which the support is positioned to hold the wireless communication component in the compartment while the closure is in its closed position and a second position in which the support is positioned to hold the wireless communication component so at least a portion of the wireless communication component extends through the opening for facilitating access to the wireless communication component when the closure is in the open position.

12. A mobile wireless communication system as set forth in claim 11 further comprising a pneumatic actuator adapted to move the support between the first and second positions.

13. A mobile wireless communication system as set forth in claim 12 wherein the pneumatic actuator is connected to the support and to a bottom of the container.

14. A mobile wireless communication system as set forth in claim 13 wherein the pneumatic actuator extends generally along the bottom of the container when the support is in the first position.

15. A mobile wireless communication system as set forth in claim 14 wherein the pneumatic actuator is in a retracted configuration when the support is in the first position and in an extended configuration when the support is in the first position.

16. A mobile wireless communication system as set forth in claim 15 wherein the support comprises a frame having an opening configured to allow the wireless communication component so slide into the frame so the frame extends around the top, bottom, and all sides of the component, the frame being secured at its top for pivoting movement relative to the container, the pneumatic actuator being secured to the frame at a position below the top of the frame.

17. A mobile wireless communication system as set forth in claim 16 wherein the pneumatic actuator comprises a pneumatic spring biased toward its extended configuration.

18. A mobile wireless communication system as set forth in claim 11 wherein the support comprises a frame having an opening configured to allow the wireless communication component so slide into the frame, said opening of the frame being positioned to face a side of the container when the support is in the first position and to extend above the opening of the container when the support is in the second position and the closure of the container is in the open position.

19. A mobile wireless communication system as set forth in claim 18 in combination with said wireless communication component, the wireless communication component having a panel including at least one of a control and a display, the panel facing the same side of the container as said opening in the frame when the support is in the first position.

20. A mobile wireless communication system as set forth in claim 19 wherein the panel is accessible through said opening in the frame when the closure is in its open position and the support is in its second position.

21. A mobile wireless communication system as set forth in claim 11 wherein the container comprises a hard outer shell.

22. A cable clip for securing one or more relatively small diameter cables to a larger diameter tubular support,
the clip comprising a body made of a resilient material and extending partially around a central space having a generally circular cross section,
wherein the body is configured so there is an opening for relative movement of the tubular support and body to snap the tubular support into the central space through the opening so the tubular support extends axially through the central opening and segments of the body are positioned to adjoin the tubular support,
the body having a plurality of lobes extending radially outward from the central space between said segments thereof to define cable-receiving spaces,
the cable-receiving spaces defined by the lobes being generally circular extensions of the central opening for holding one of the relatively smaller diameter cables adjacent the relatively larger diameter tubular support.

23. A cable clip as set forth in claim 22 wherein the lobes are comprised of C-shaped segments configured so the relatively smaller diameter cables can be snapped into the cable receiving spaces before the relatively larger tubular support is snapped into the central space.

24. A cable clip as set forth in claim 22 wherein the cable-receiving spaced defined by one of said lobes has a first diameter and the cable-receiving space defined by another of said lobes has a second diameter different from the first diameter.

25. A cable clip as set forth in claim 22 wherein the cable-receiving spaced defined by one of said lobes has a first diameter and the cable-receiving space defined by two others of said lobes have a second diameter different from the first diameter, the lobe defining the cable-receiving opening being positioned generally opposite the opening for snapping the tubular support into the central space.

26. A cable clip as set forth in claim 25 wherein the body has a pair of ends on opposite sides of the opening, the ends being doubled back on themselves to form hooks, the hooks defining additional cable-receiving spaces at the ends of the body.

27. A cable clip as set forth in claim 26 wherein the clip is configured so cables can be snapped into the cable-receiving spaces at the ends of the body while the tubular support is snapped into the central space.

28. A cable clip as set forth in claim 27 wherein the body has a radially outwardly extending rib extending from the lobes and the segments of the body between the lobes.

29. A cable clip as set forth in claim 28 wherein the body is a unitary body molded as one piece from a moldable polymeric material.
